(19) United States
(12) Patent Application Publication
(10) Pub. No.: US 2014/0201702 A1
(43) Pub. Date: Jul. 17, 2014

(54) Automatic Identification of Affected Product Assets with Work Items

(71) Applicant: INTERNATIONAL BUSINESS MACHINES CORPORATION, Armonk, NY (US)

(72) Inventors: Todd Eric Kaplinger, Durham, NC (US); Eric Woods, Durham, NC (US)

(73) Assignee: International Business Machines Corporation, Armonk, NY (US)

(21) Appl. No.: 13/740,509

(22) Filed: Jan. 14, 2013

(51) Int. Cl. G06F 9/44

(52) U.S. Cl. CPC G06F 8/70
USPC 717/101

(57) ABSTRACT

A work description for a computing system or environment is automatically associated with the affected source components, such as source code modules, web pages, icons, etc., by analyzing the textual description for a change to produce keywords, concepts, and metadata from the textual description; analyzing the source components in a component repository against the keywords, the concepts, and the metadata; identifying source code areas within the source components for changing according to the keywords, concepts, and metadata; and producing a report indicating the source areas for changing. The analysis may employ pattern matching, deep semantic relationship detection, shallow semantic relationship detection, scoring, weighting, logic matching, and other natural language processing techniques.

### FIELD OF THE INVENTION

The invention generally relates to systems and methods for automating and improving tasks in information technology management, administration and installation.

### BACKGROUND OF INVENTION

In the context of the present disclosure and the related art, “work items” represent a unit of work to be taken against a software base, such as bug reports, feature requests, new development tasks, and other human-entered assignment. Today, work items are not correlated with the software code to which they are targeting. This correlation must be manually established by a software developer familiar with the code base. Because significant familiarity with the software code base is required for a human to identify which product assets must be revised, updated, changed, or even written from scratch, this poses a cost and efficiency bottleneck to development, installation, and upgrading of computing systems. Since the relevant sections of the code must first be identified by a high-expertise person, work items take longer to complete.

This problem is especially applicable to product acquisitions, in which products must undergo transformations to become conformant to the acquirer's corporate product standards (e.g. rebranding). For example, if Company Z acquires software Product Y from Company X, someone with familiarity of all the components of Product Y must identify all components which must be revised to show the logo and contact information of Company Z, to present user interfaces consistent with Company Z's UI standard, to implement security consistent with Company Z's policies, etc.

A similar situation may arise for “private labeling” of software products, such as web browser which can be customized to appear to be produced by a company but which are in fact sourced from another company.

Further, such software products may include products beyond traditional executable programs, such as web pages, scripts associated with web pages, and mobile “apps”.

And, similar situations may arise as products are “localized” for other jurisdictions, countries, and cultures, in which logos, warnings, license agreements, contact information, and the like must be revised and updated throughout multiple software components per local requirements.

### SUMMARY OF EXEMPLARY EMBODIMENTS OF THE INVENTION

A work description for a computing system or environment is automatically associated with the affected source components, such as source code modules, web pages, icons, etc., by analyzing the textual description for a change to produce keywords, concepts, and metadata from the textual description; analyzing the source components in a component repository against the keywords, the concepts, and the metadata; identifying source code areas within the source components for changing according to the keywords, concepts, and metadata; and producing a report indicating the source areas for changing. The analysis may employ pattern matching, deep semantic relationship detection, shallow semantic relationship detection, scoring, weighting, logic matching, and other natural language processing techniques.

### BRIEF DESCRIPTION OF THE DRAWINGS

The description set forth herein is illustrated by the several drawings.

FIG. 1 provides an example configuration and model of cooperation between computer system components according to the invention to identify and report which product components are affected by the work item.

FIG. 2a illustrates an example logical process according to the present invention and correlating to the cooperation shown in FIG. 1, and FIG. 2b provides additional details to the exemplary logical process to perform the relevancy search and to produce an affected components report as referenced in FIG. 2a.

FIG. 3 depicts an example configuration and model of cooperation between computer system components according to the invention to automatically create a work package for one or more developers.

FIG. 4 illustrates an example logical process according to the present invention and correlating to the cooperation shown in FIG. 3.

FIG. 5 sets forth a generalized architecture of computing platforms suitable for at least one embodiment of the present and the related inventions.

### DETAILED DESCRIPTION OF EXEMPLARY EMBODIMENT(S) OF THE INVENTION

The inventors of the present and the related invention have recognized problems not yet recognized by those skilled in the relevant arts. As stated in the Background section, for the context and field of the present disclosure, “work items” represent a unit of work to be taken against a software base, including bug reports, feature requests, new development tasks, or other human-entered assignment, driven by a sales event, work order, localization effort, product acquisition, etc.

The present inventors have recognized, according to presently available technology, these work items are not correlated with the code to which they are targeting. Instead, the problem arises that this correlation must be manually established by one or more software developers with a high-degree of familiarity with the entire code base. Such software developers are a rare resource in most organizations, and when they do exist, they tend to be in high demand for actual software development activities. Since the relevant sections of the code must first be identified, requiring product expertise, work items take longer to complete.

This problem is especially applicable to product acquisitions, in which products must undergo transformations to become conformant to the policies and standards of the acquiring entity.

The present inventors have found existing technologies which are useful in tracking software problems using a problem tracking system, tracking work items for projects, creating recommendations which are situation-aware based on correlations, and which discover relationships in software repositories. However, even though some of the concepts and features of these available technologies may be useful in rendering a solution to the presently considered problem, none of them provide an actual solution to the present problem.

In particular, the available technologies provide methods of tracking bugs, feature requests and new development tasks against a software code base, but it fails to automatically identify code that is targeted by a work request.

The inventors have therefore set out to provide a solution as described herein to fulfill this unmet and unrecognized need in the art. Disclosed in the following paragraphs is a method of associating work items to relevant sections of code, wherein the work item's targeted sections of code are automatically identified by employing an advanced relevancy search engine to compare work item metadata to textual descriptions embedded in the code.

Such relevancy search engines may use any or all of the following processes: pattern matching, deep semantic relationship detection, shallow semantic relationship detection, scoring, weighing, logic matching, and natural language processing. One such available technology is the Watson™ architecture by International Business Machines (IBM)™.

IBM has published details of computing methods and technologies that are able to assist humans with certain types of semantic query and search operations, such as the type of natural question-and-answer paradigm of a medical environment. IBM researchers and scientists have been working on Deep Question-Answering (DeepQA) methods that are able to understand complex questions posed (and input) in natural language, and are able to answer the question with enough precision, confidence, and speed to augment human handling of the same questions within a given environment, such as a medical inquiry and diagnostic paradigm where time-to-answer is of the essence.

DeepQA is an application of advanced Natural Language Processing, Information Retrieval, Knowledge Representation and Reasoning, and Machine Learning technologies to the field of open-domain question answering, all executing on a suitable computing platform. Such methods of hypothesis generation, evidence gathering, analysis, and scoring may be effectively executed by a wide range of computing platforms.

Similarly, IBM has also published computing methods which combine semantic elements with information search elements to form Unstructured Information Management Architecture (UIMA), which is now maintained as an open source project by the Apache organization.

Whereas ample information is available in the public domain regarding DeepQA and UIMA, the present disclosure presumes those ordinarily skilled in the art may access and apply that information to realized embodiments of the following invention.

According to at least one embodiment according to the present invention, a high-level logical process performed and aided by a computer is as follows:
1. A work item is opened against an entire software repository which describes a unit of work that will change the software's functionality or user interface (UI) to some degree or another.
2. The system according to the present invention analyzes the work item and compares it against the software source code in the software repository.
3. The system according to the invention automatically identifies the relevant sections of code that are affected by the work item (i.e. the work item's target).
4. The system according to the invention generates a report of the sections of code that are likely targeted by the work item, helping developers make the changes faster.

Optionally, a system according to the invention may interface to a software configuration control system to automatically “check out” the identified software source code, which would change the status of each identified sections of code to being under revision or development so that a software developer could proceed more directly to making changes to the sections of code and then check them back into the change control system.

A more detailed exemplary embodiment of a logical process according to the present invention contains the following steps, actions, interfaces and interactions:
1. The source code is first indexed and ingested by the system, capturing all textual descriptions embedded in the source code, such as but not limited to source code comments describing functionality or purpose, accessibility tags (e.g. “alt” or “longdesc”), element content such as hypertext markup language (HTML) text content, which will be surfaced on the UI, and any other natural language intended for human consumption, like log statements and UI exports, which can be machine-read by the system.
2. The work item's textual description and other available metadata are input into the system.
3. The system employs one or more processes of pattern matching, deep/shallow semantic relationship detection, and scoring methods to identify relevant sections of code associated with a work item. One available computing platform which provides such processes that can be utilized and co-opted by an application program is the previously-mentioned IBM Watson™ deepQA architecture. Training data may be used to train the system's artificial intelligence (AI) engine to effectively rank the scorers.
4. A report is generated by the system indicating relevant sections of code within the software source code repository that are likely associated with the work item.

In a very realistic example, consider an acquisition of Company B by Company A, which results in the need to modify the program products of Company B to reflect everything from the Company A logo, to Company A's contact information, and to implement Company A's user interface and security policies.

A first work item, then, leads to a series of more specific work items that will be distributed to Company A's software developers to make the product conformant in the several ways as mentioned. For example, a first work item is submitted with the description: “Update all references from Company B to Company A.” The system understands the work item's goal of “update all references to Company B”, and finds all references to Company B in the source code. The system then generates a report indicating the relevant sections of source code that reference Company B (by name, slogan, logo, icon or other branding). Another work item may be input into the system “Update all encryption to meet minimum encryption of Triple DES”, and the system would search, score and identify all software components in the repository which utilize, call or include encryption methods or library functions. These would be identified in a report and provided to software development for further action.

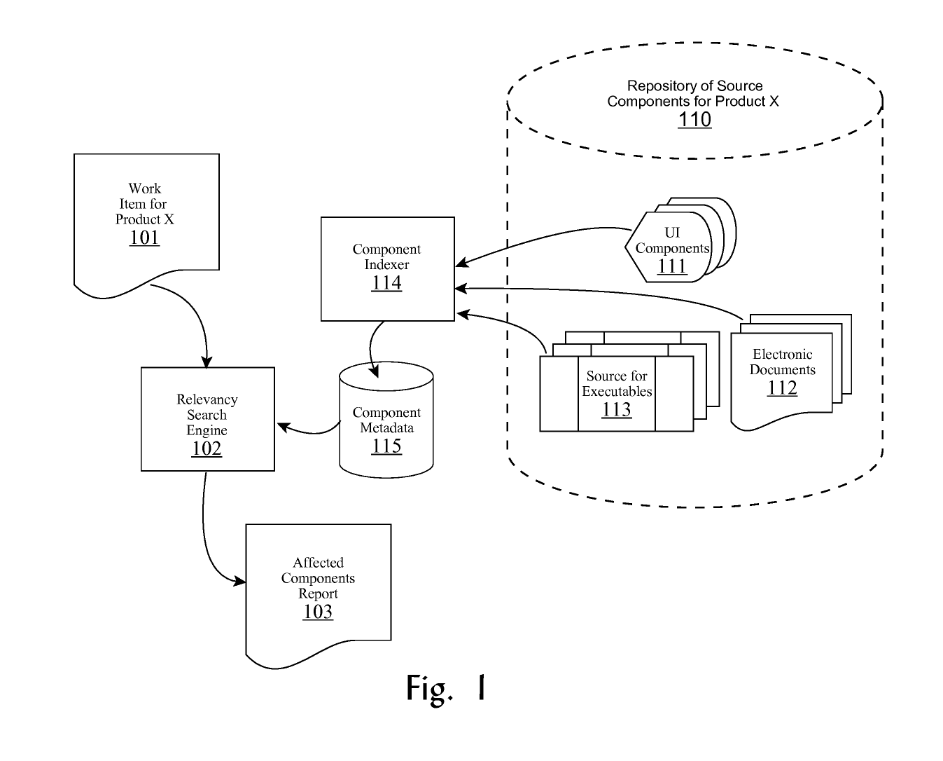

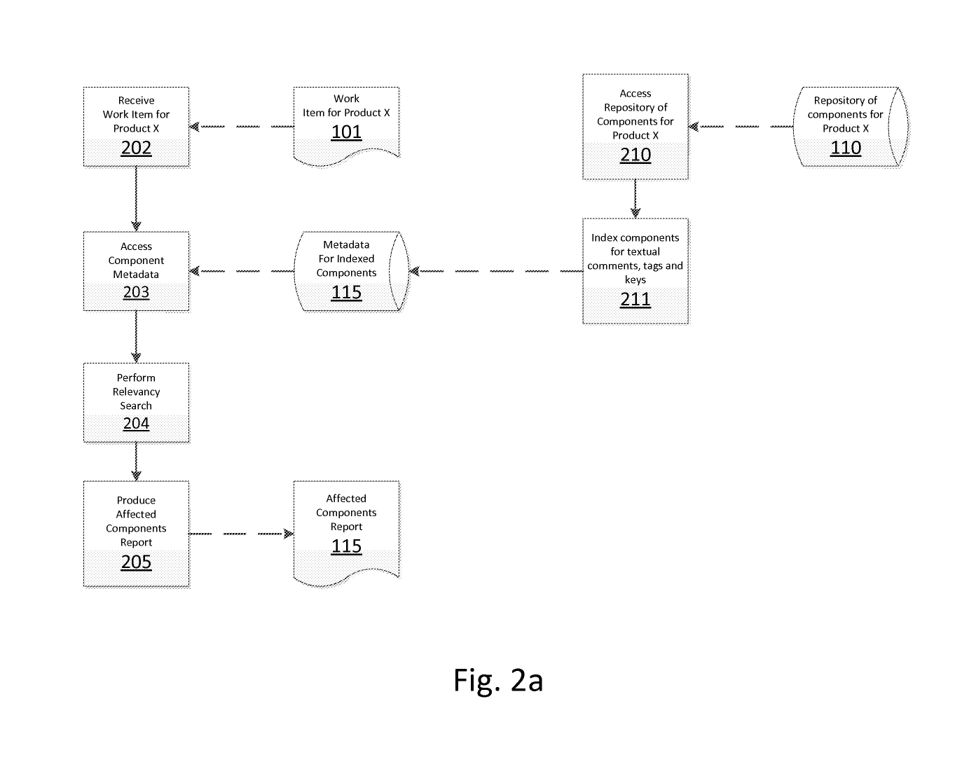

Referring now to FIG. 1, an example configuration of computing system functions and components is shown in which a work item (101) for Product X is analyzed as previously discussed. A component indexer (114) creates component metadata (115) from the source components (111, 112, and 113) for Product X as found in the repository (110). Examples of such source components include source code modules, computer-displayable icons, user interface definitions, user interface elements, electronic images, electronic documents, and hypertext markup language entries and pages. A relevancy search engine (102) then compares that metadata (115) to metadata of the work item (101), and produces an affected components report (103).

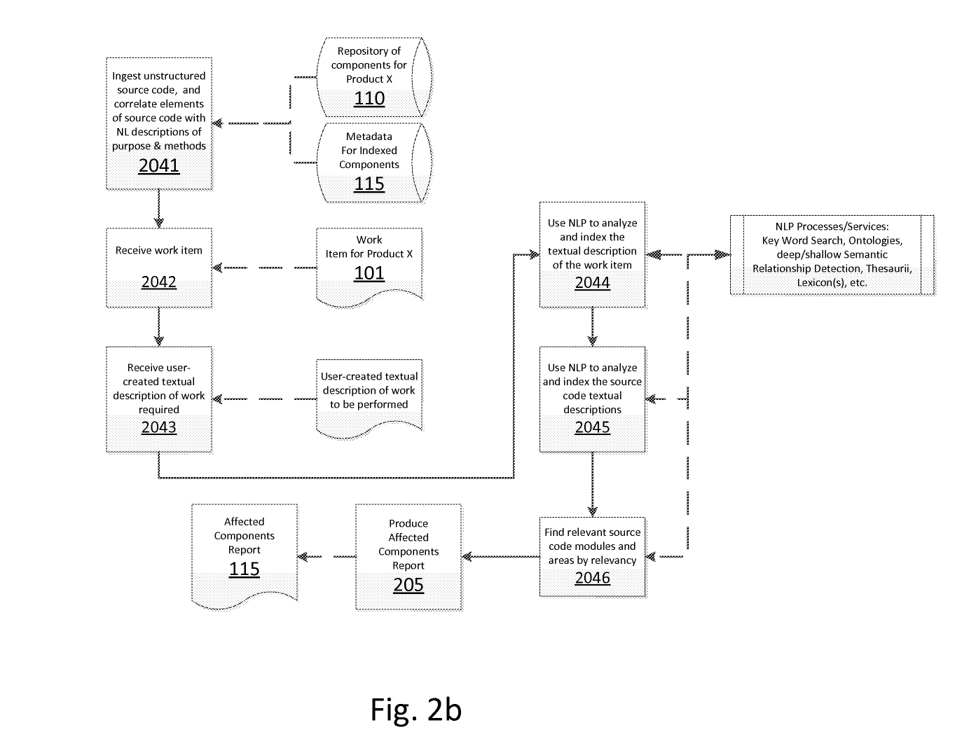

FIG. 2a shows an example logical process according to the present invention and corresponding to the example of FIG. 1, in which the work item (101) is received (202), the metadata for the components (115) is accessed, and the relevancy search (204) is performed. The report (115) is finally produced (205). In one embodiment, the accessing and indexing (210, 211) of the source components (110) is performed in advance of producing the report, and in other embodiments, these processes can be performed on-demand at the time of receiving the work item, continuously, periodically, or responsive to a change in the components in the repository (110).

Now referring to FIG. 2b, additional details of an exemplary logical process to perform the relevancy search (204) and to produce (205) an affected components report (115) are shown:
2041. As a pre-processing step, the system correlates elements of source code in a repository with natural language descriptions of its purpose, contained methods, or both. To accomplish this, the system may ingest unstructured content in the source code, including comments, file names, method names, and strings in the source code. And, the system may generate a natural language description of methods in the code.
2042. A user-created a work item representing a unit of work against the repository of source code is received by the system via an input method, such as through a form, a screen, or an input file.
2043. A user-created textual description of the work to be completed is also received by the system via in input method, such as through a form, a screen, or an input file.
2044. Using available Natural Language Processing techniques, such as NLP modules available from other products, services from on-demand providers, or from component licensing suppliers, the system analyzes and indexes the textual description of the work item. Such analysis may include available processes such as key word detection, using ontologies to find related words, performing deep/shallow semantic relationship detection, etc.
2045. In the same manner, the system indexes and analyzes the natural language descriptions correlated with the source code.
2046. The system compares the work item description with the source code descriptions to find code that is relevant to or the target of the work item. The system may attempt to infer the work item's purpose based on the description. For example, for a work item description of “Update all references from Company B to Company A”, the system may search for textual references in the code modules related to the string “Company B”, including variations, acronyms and synonyms associated with “Company B”. A company name such as “International Business Machines Corporation” is synonymous with “IBM Corp.”, and is represented by the acronym “IBM”, as well, so a thesaurus and/or lexicon may be employed to assist the system identifying all instances to be modified. Lexicons and thesauri are typical components of NLP systems, and can be used in their conventional sense for this new purpose and operation according to the present invention.

Responsive to the related and affected source code areas and components being identified, the system exposes this information to the end-user (115), such as by producing (205) a report displayed on a computer, a report printed to an output device, or in an output file, to expedite the work item (e.g. append to the work item, generate a report, etc).

For an illustration of such a logical process in operation, consider this example:
(a) The system pre-processes a repository of source code, in which the code refers to Company B at several places in several different formats, such as:
   “Copyright 2012 by Company_B Inc.”;
   “CoB”; and
   “Company B”.
(b) A user-created work item is received by the system via a screen form input: “Update all references from Company B to Company A”.
(c) The system scans for relevant source code to the phrase “Company B”, its synonyms and acronyms, as previous described. In this case, source code containing references to Company B will be tagged as relevant.
(d) Once source code is identified, system exposes these source fragments to end-user for updating.

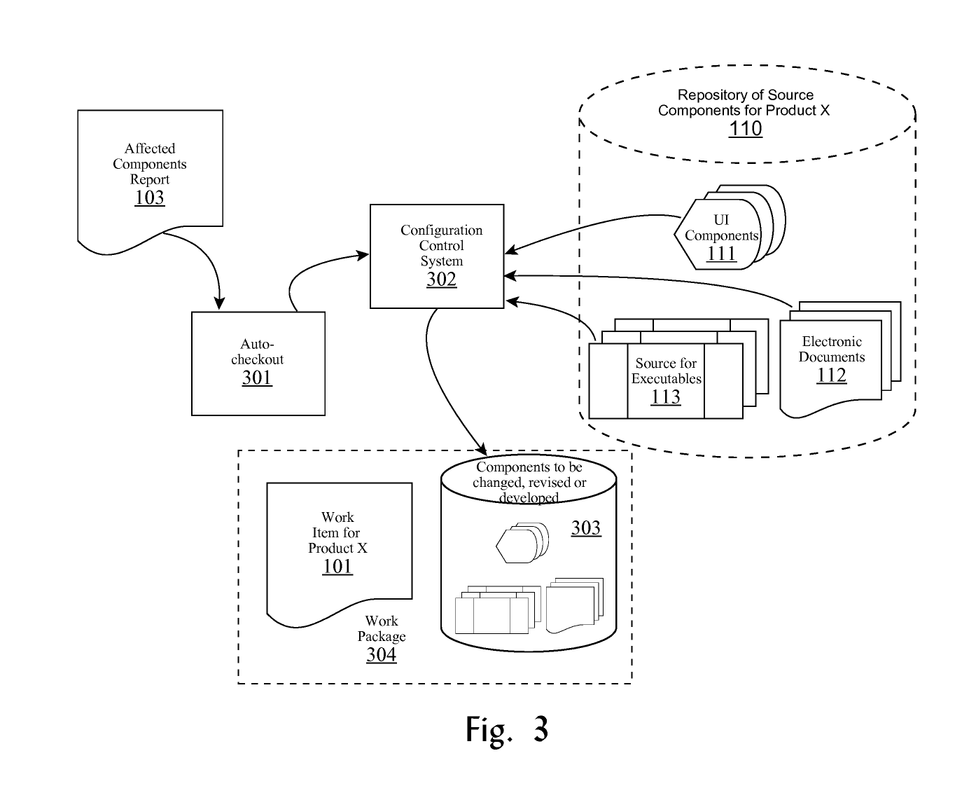

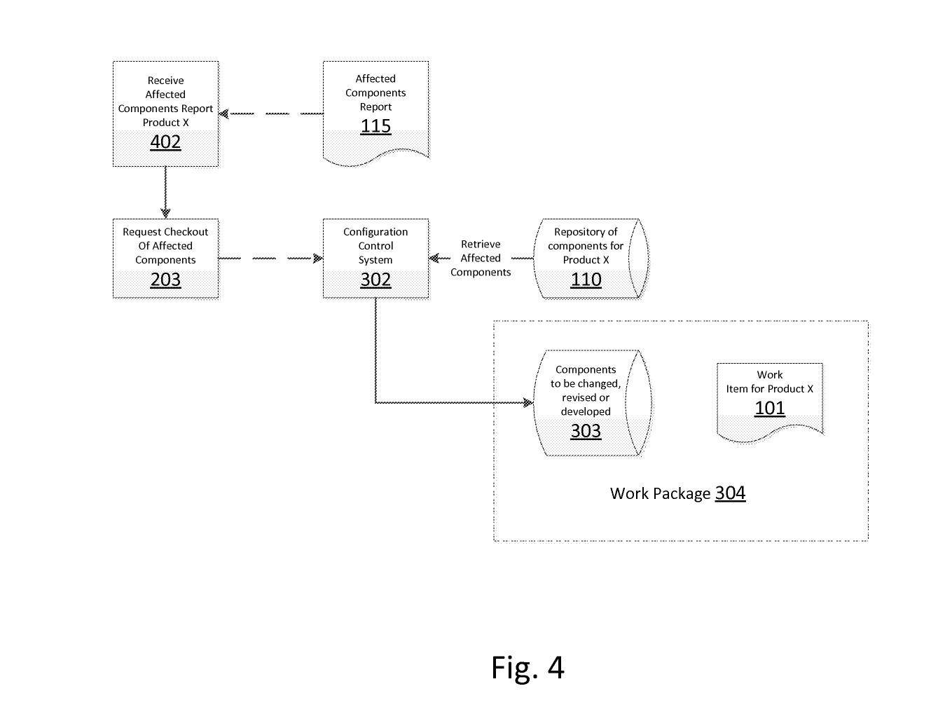

FIG. 3 shows an example configuration of computing system functions and components in which a work package (304) for implementing the work item (101) into Product X is automatically created for the convenience of one or more developers. And auto-checkout function (301) uses the affected components report (103) to request checkout of the affected components from a configuration control system (302), such as a Tivoi CCMDB™. The configuration control system would then checkout the requested components, placing them into a temporary repository (303) or protected status, thereby yielding the work package (304). FIG. 4 sets out a logical process according to the example of FIG. 3 in which the affected components report (115) is received (402), and the components are requested (203) from the configuration control system (302).

Suitable Computing Platform. The preceding paragraphs have set forth example logical processes according to the present invention, which, when coupled with processing hardware, embody systems according to the present invention, and which, when coupled with tangible, computer readable memory devices, embody computer program products according to the related invention.

Regarding computers for executing the logical processes set forth herein, it will be readily recognized by those skilled in the art that a variety of computers are suitable and will become suitable as memory, processing, and communications capacities of computers and portable devices increases. In such embodiments, the operative invention includes the combination of the programmable computing platform and the programs together. In other embodiments, some or all of the logical processes may be committed to dedicated or specialized electronic circuitry, such as Application Specific Integrated Circuits or programmable logic devices.

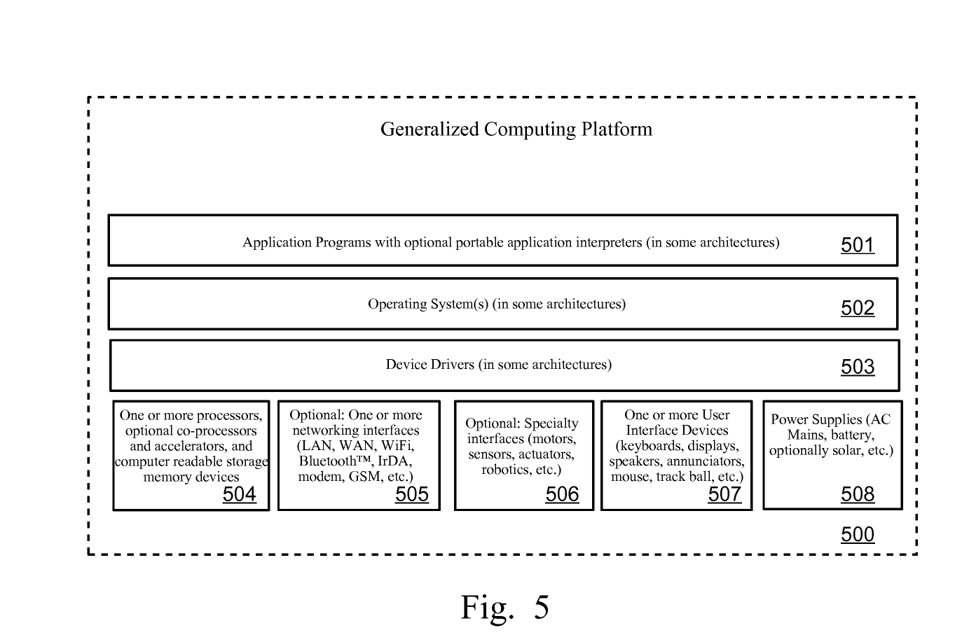

The present invention may be realized for many different processors used in many different computing platforms. FIG. 5 illustrates a generalized computing platform (500), such as common and well-known computing platforms such as “Personal Computers”, web servers such as an IBM iSeries™ server, and portable devices such as personal digital assistants and smart phones, running a popular operating systems (502) such as Microsoft™ Windows™ or IBM™ AIX™, Palm OS™, Microsoft Windows Mobile™, UNIX, LINUX, Google Android™, Apple iPhone iOS™, and others, may be employed to execute one or more application programs to accomplish the computerized methods described herein. Whereas these computing platforms and operating systems are well known an openly described in any number of textbooks, websites, and public “open” specifications and recommendations, diagrams and further details of these computing systems in general (without the customized logical processes of the present invention) are readily available to those ordinarily skilled in the art.

Many such computing platforms, but not all, allow for the addition of or installation of application programs (501) which provide specific logical functionality and which allow the computing platform to be specialized in certain manners to perform certain jobs, thus rendering the computing platform into a specialized machine. In some “closed” architectures, this functionality is provided by the manufacturer and may not be modifiable by the end-user.

The “hardware” portion of a computing platform typically includes one or more processors (504) accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces (505) may be provided, as well as specialty interfaces for specific applications. If the computing platform is intended to interact with human users, it is provided with one or more user interface devices (507), such as display(s), keyboards, pointing devices, speakers, etc. And, each computing platform requires one or more power supplies (battery, AC mains, solar, etc.).

Conclusion. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

It should also be recognized by those skilled in the art that certain embodiments utilizing a microprocessor executing a logical process may also be realized through customized electronic circuitry performing the same logical process(es).

It will be readily recognized by those skilled in the art that the foregoing example embodiments do not define the extent or scope of the present invention, but instead are provided as illustrations of how to make and use at least one embodiment of the invention. The following claims define the extent and scope of at least one invention disclosed herein.

What is claimed is:

1. A method for associating work description with affected source components comprising:
analyzing by a computer a first textual description for a work item to a program product to produce keywords, concepts, or metadata from the first textual description;
indexing by a computer a plurality of source components in a component repository by keywords, concepts, or metadata, wherein the source components are part of the program product, and wherein the indexing includes at least analyzing a second textual description embedded in at least one source component;
determining relevancy by a computer by comparing the keywords, concepts, or metadata of the work item to the keywords, concepts, or metadata of the source components;
identifying by a computer one or more source code areas within the source components which will be affected or changed by the work item according to the relevant keywords, concepts, metadata, or a combination of the keywords, concepts and metadata; and
producing by a computer a first report indicating the source areas for changing.

2. The method as set forth in claim 1 wherein the determining of relevancy comprises using at least one process selected from the group consisting of pattern matching, deep semantic relationship detection, shallow semantic relationship detection, scoring, weighting, logic matching, and natural language processing.

3. The method as set forth in claim 1 wherein the work item comprises at least one item selected from the group consisting of a problem identification, an enhancement description, a feature addition, a rebranding task, a localization task, and a new development task.

4. The method as set forth in claim 1 wherein the source components comprise at least one component selected from the group consisting of a source code module, a computer-displayable icon, a user interface definition, a user interface element, an electronic image, an electronic document, and a hypertext markup language entry.

5. The method as set forth in claim 1 further comprising generating by a computer a work request for the change to the identified components.

6. The method as set forth in claim 5 further comprising generating by the computer a second report for the work request.

7. The method as set forth in claim 1 wherein the first report comprises a human-readable report.

8. A computer program product for associating work description with affected source components, the computer program product comprising a computer readable storage device having program code embodied therewith, the program code being executable by a computer to:
analyze a first textual description for a work item to a program product to produce keywords, concepts, or metadata from the first textual description;
index a plurality of source components in a component repository by keywords, concepts, or metadata, wherein the source components are part of the program product, and wherein the indexing includes at least analyzing a second textual description embedded in at least one source component;
determine relevancy by comparing the keywords, concepts, or metadata of the work item to the keywords, concepts, or metadata of the source components;
identify one or more source code areas within the source components which will be affected or changed by the work item according to the relevant keywords, concepts, metadata, or a combination of the keywords, concepts and metadata; and
produce a first report indicating the source areas for changing.

9. The computer program product as set forth in claim 8 wherein the program code to determine relevancy comprises program code to use at least one process selected from the group consisting of pattern matching, deep semantic relationship detection, shallow semantic relationship detection, scoring, weighting, logic matching, and natural language processing.

10. The computer program product as set forth in claim 8 wherein the work item comprises at least one item selected from the group consisting of a problem identification report, an enhancement description, a feature addition, a rebranding task, a localization task, and a new development task.

11. The computer program product as set forth in claim 8 wherein the source components comprise at least one component selected from the group consisting of a source code module, a computer-displayable icon, a user interface definition, a user interface element, an electronic image, an electronic document, and a hypertext markup language entry.

12. The computer program product as set forth in claim 8 wherein the program code further comprise code to generate a work request for change to the identified components.

13. The computer program product as set forth in claim 12 where the program code further comprise code to generate a second report for the work request.

14. The computer program product as set forth in claim 8 wherein the first report comprises a human-readable report.

15. A system for associating work description with affected source components comprising:
a computer system having a processor;
an analyzer portion of the computer system for analyzing a first textual description for a work item to a program product to produce keywords, concepts, or metadata from the first textual description;
an indexer portion of the computer system for indexing a plurality of source components in a component repository for keywords, concepts, or metadata, wherein the source components are part of the program product, and wherein the indexing includes at least analyzing a second textual description embedded in at least one source component;
a search engine portion of the computer system for determining relevancy by comparing the keywords, concepts, or metadata of the work item to the keywords, concepts, or metadata of the source components;
an identifier portion of the computer system for identifying one or more source code areas within the source components which will be affected or changed by the work item according to the relevant keywords, concepts, metadata, or a combination of the keywords, concepts and metadata; and
a report generator portion of the computer system for producing a first report indicating the source areas for changing.

16. The system as set forth in claim 15 wherein the search engine portion is for using at least one process selected from the group consisting of pattern matching, deep semantic relationship detection, shallow semantic relationship detection, scoring, weighting, logic matching, and natural language processing.

17. The system as set forth in claim 15 wherein the work item comprises at least one item selected from the group consisting of a problem identification report, an enhancement description, a feature addition, a rebranding task, a localization task, and a new development task.

18. The system as set forth in claim 15 wherein the source components comprise at least one component selected from the group consisting of a source code module, a computer-displayable icon, a user interface definition, a user interface element, an electronic image, an electronic document, and a hypertext markup language entry.

19. The system as set forth in claim 15 further comprising a request generator portion of the computer system for generating a work request for the change to the identified components.

20. The system as set forth in claim 19 wherein the report generator is further for generating a second report for the work request.

21. The method as set forth in claim 15 wherein the first report comprises a human-readable report.
